(19) United States
(12) Patent Application Publication
(10) Pub. No.: US 2026/0360024 A1
(43) Pub. Date: Nov. 12, 2026

(54) LAYOUT-CONDITIONED IMAGE GENERATION FOR OBJECT-CENTRIC IMAGE GENERATION

(71) Applicant: ADOBE INC., SAN JOSE, CA (US)

(72) Inventors: Supreeth Narasimhaswamy, San Jose, CA (US); Hareesh Ravi, San Jose, CA (US)

(21) Appl. No.: 19/200,898

(22) Filed: May 7, 2025

(51) Int. Cl. G06T 11/00; G06T 5/70

(52) U.S. Cl. CPC G06T 11/00; G06T 5/70; G06T 2207/20182

(57) ABSTRACT

A method, apparatus, non-transitory computer readable medium, and system for generating a synthetic image includes obtaining an input prompt comprising a representation of an object and a depth value for the object. In some cases, the input prompt is encoded to generate a text embedding representing the object and the depth value. An image generation model generates a synthetic image based on the text embedding, wherein the synthetic image depicts the object having the depth value.

### BACKGROUND

The following generally relates to machine learning, and more specifically to image generation using a machine learning model. Machine learning algorithms build a model based on sample data, known as training data, to make a prediction or a decision in response to an input without being explicitly programmed to do so. One area of application for machine learning is image generation.

For example, a machine learning model can be trained to predict features for an image in response to an input prompt, and then generate the image based on the predicted features. In some cases, the prompt can be used to perform complex image manipulation and compositing. Such image generation provides for a user to edit an image and generate an image with desired features and therefore makes image generation easier for a layperson.

### SUMMARY

The present disclosure describes systems and methods for image generation. Embodiments of the present disclosure include an image processing apparatus that performs layout-conditioned image generation based on an input prompt and location information. For example, the location information includes spatial arrangement and depth information associated with an element described in the input prompt. In some examples, the spatial arrangement is encoded as an ellipse. In some examples, the depth information includes depth disparity value for a centroid location associated with the element. In some cases, a text encoder of the image processing apparatus generates an embedding corresponding to the ellipse and the depth disparity value. An image generation model including a diffusion transformer is trained to generate a synthetic image based on the embedding.

A method, apparatus, and non-transitory computer readable medium for image processing are described. One or more aspects of the method, apparatus, and non-transitory computer readable medium include obtaining an input prompt including an object and a depth value for the object; encoding the input prompt to generate a text embedding representing the object and the depth value; and generating, using an image generation model, a synthetic image based on the text embedding, wherein the synthetic image depicts the object having the depth value.

A method, apparatus, and non-transitory computer readable medium for image processing are described. One or more aspects of the method, apparatus, and non-transitory computer readable medium include obtaining an input prompt including an object and three-dimensional (3D) location information for the object; encoding the input prompt to generate a text embedding representing the object and the 3D location information; and generating, using an image generation model, a synthetic image based on the text embedding, wherein the synthetic image depicts the object having the 3D location information.

An apparatus and system for image processing are described. One or more aspects of the apparatus and system include a memory component; a processing device coupled to the memory component, the processing device configured to perform operations including: obtaining an input prompt including an object and a depth value for the object; encoding the input prompt to generate a text embedding representing the object and the depth value; and generating, using an image generation model, a synthetic image based on the text embedding, wherein the synthetic image depicts the object having the depth value.

### BRIEF DESCRIPTION OF THE DRAWINGS

FIG. 1 shows an example of an image processing system according to aspects of the present disclosure.

FIG. 2 shows an example of a method for image generation according to aspects of the present disclosure.

FIG. 3 shows an example of an image generation process according to aspects of the present disclosure.

FIG. 4 shows an example of an image generation process with orientation control according to aspects of the present disclosure.

FIG. 5 shows an example of an image generation process with ordering control according to aspects of the present disclosure.

FIG. 6 shows an example of a transformer network according to aspects of the present disclosure.

FIG. 7 shows an example of a latent diffusion process according to aspects of the present disclosure.

FIG. 8 shows an example of a diffusion transformer network according to aspects of the present disclosure.

FIG. 9 shows an example of a U-Net architecture according to aspects of the present disclosure.

FIG. 10 shows an example of a denoising diffusion process according to aspects of the present disclosure.

FIG. 11 shows an example of a method for image processing according to aspects of the present disclosure.

FIG. 12 shows an example of a method of training a ML model according to aspects of the present disclosure.

FIG. 13 shows an example of a method of training a diffusion model according to aspects of the present disclosure.

FIG. 14 shows an example of a computing device according to aspects of the present disclosure.

FIG. 15 shows an example of an image processing apparatus according to aspects of the present disclosure.

### DETAILED DESCRIPTION

The present disclosure describes systems and methods for image generation. Embodiments of the present disclosure include an image processing apparatus that performs layout-conditioned image generation based on an input prompt and location information. For example, the location information includes spatial arrangement and depth information associated with an element described in the input prompt. In some examples, the spatial arrangement is encoded as an ellipse. In some examples, the depth information includes depth disparity value for a centroid location associated with the element. In some cases, a text encoder of the image processing apparatus generates an embedding corresponding to the ellipse and the depth disparity value. An image generation model including a diffusion transformer is trained to generate a synthetic image based on the embedding.

Existing image generation systems perform image generation based on an input text prompt. However, such systems often struggle with accurately positioning an element based on a user defined input. For example, existing systems are unable to simultaneously control the spatial arrangement and depth value of an element within an image, particularly in case of an image with two or more elements. Moreover, such an image generation system is not able to maintain quality of the generated image while performing the spatial arrangement.

In some cases, an existing image generation system uses a skeleton-based control for placing an element in an image. However, such a system is unable to accurately capture fine details within an image and can depict inconsistencies within the image. In some cases, an existing image generation system uses a bounding box for controlling the placement of elements which also is unable to accurately capture fine details within an image resulting in low-quality images.

By contrast, embodiments of the present disclosure include an image processing apparatus that includes an implicit control system to precisely manage spatial location of an element (or a plurality of elements) within an image. Additionally, the image processing apparatus is able to control the depth disparity information for the element within the image. Accordingly, by simultaneously performing spatial control and depth information of an element within an image, embodiments of the present disclosure are able to ensure accurate placement and z-ordering of an element within the image.

Embodiments of the present disclosure are configured to perform an image generation process. In some cases, the image processing apparatus provides for a user to generate an image based on placing an element. In some cases, a text encoder of the image processing apparatus is used to encode the input prompt describing the element. For example, the text encoder generates a text embedding associated with the input text prompt. Additionally, the text encoder encodes the spatial location and depth information associated with the element. For example, the spatial location and depth information are provided as input by the user to the text encoder.

According to an embodiment, the text encoder is configured to encode the spatial location of the element as an ellipse. In some cases, the ellipse is defined using parameters including, but not limited to, centroid of the ellipse, axis lengths of the ellipse, and an orientation of the ellipse. In some cases, the text encoder is configured to encode the depth information associated with the element. For example, the depth information refers to the depth disparity value for the centroid location of the element. In some examples, a high value for depth disparity indicates less distance from the camera lens or a screen.

Embodiments of the present disclosure include an image processing apparatus configured to generate an image while controlling the spatial arrangement and depth information of an element described in the input prompt. In some cases, the image processing apparatus includes a text encoder and an image generation model. For example, the text encoder takes a prompt (such as a user-provided text prompt), ellipse, and depth information as input and accurately generates an embedding based on encoding the input prompt, the ellipse, and the depth information.

Additionally, in some examples, the image generation model includes a diffusion transformer network that generates an image based on using the generated embedding as guidance during the decoding process. By combining the text encoder and the image generation model, embodiments of the present disclosure are able to provide for fine-grained control over placement of an element while ensuring that each element is accurately positioned (e.g., as desired by the user) in the generated image.

Embodiments of the present disclosure are configured to perform multi-object image generation. In some cases, the image processing apparatus of the present disclosure generates an embedding to implement a spatial constraint and a depth constraint corresponding to an element in the generated image. In some cases, the image processing apparatus of the present disclosure generates the embedding including the text embedding corresponding to the input prompt. By simultaneously implementing the input prompt, the spatial constraint, and the depth constraint, embodiments of the present disclosure are able to precisely control the layout and composition of the generated image.

Embodiments of the present disclosure are configured to perform object-centric image generation while maintaining control over the spatial location and depth of an element in the generated image. In some cases, the image processing apparatus uses implicit location coordinates combined with the depth information (e.g., z-ordering) to precisely control position of an element within an image (e.g., within a scene of an image).

By simultaneously controlling spatial arrangement and depth of the element described in the input prompt to generate the image, embodiments of the present disclosure provide for a flexible and efficient image generation process. Additionally, by performing object-centric image generation that incorporates user input (including input prompt and location information), embodiments are able to ensure generation of a high-quality, user-guided image while maintaining visual integrity.

As used herein, the input prompt refers to a natural language description that defines the overall context of the image to be generated. In some cases, the input prompt includes a natural language description that defines an element to be generated. Additionally, the input prompt includes spatial information and depth information associated with the element. For example, the depth information refers to the depth disparity value associated with an element within the image to be generated. For example, the depth information refers to the depth disparity value for the centroid location of the element. In some examples, a high value for depth disparity indicates less distance from a camera lens. Similarly, in some examples, a low value for depth disparity indicates high distance from a camera lens.

As used herein, an image generation model may refer to a machine learning-based model configured to generate an image based on input data. The model may include machine learning architectures, such as neural networks, generative adversarial networks (GANs), transformer-based models, or a diffusion network. In some cases, the image generation model may utilize trained parameters, latent representations, or probabilistic sampling techniques to produce outputs that resemble or extend the input data while maintaining desired stylistic or structural attributes.

As used herein, the ellipse refers to, or includes, a parameter (or parameters) that define the location and size information of an element in an image. For example, the ellipse is defined using a centroid location, major and minor axis, and an orientation (in degrees). As used herein, the synthetic image or image refers to a synthetized image where the element (or a plurality of elements) are placed according to the spatial constraint and the depth constraint provided as input. Additionally, the synthetic image or image refers to the synthetized image where the element (or the plurality of elements) accurately align with the input prompt while ensuring a coherent visual composition.

By providing an ellipse that accurately controls spatial and depth information associated with an element within an image, embodiments of the present disclosure are able to precisely control the layout of the generated image. Additionally, by combining the natural language (i.e., text) prompt with the spatial and depth information during the image decoding process, embodiments of the present disclosure are able to accurately depict an element in the generated synthetic image.

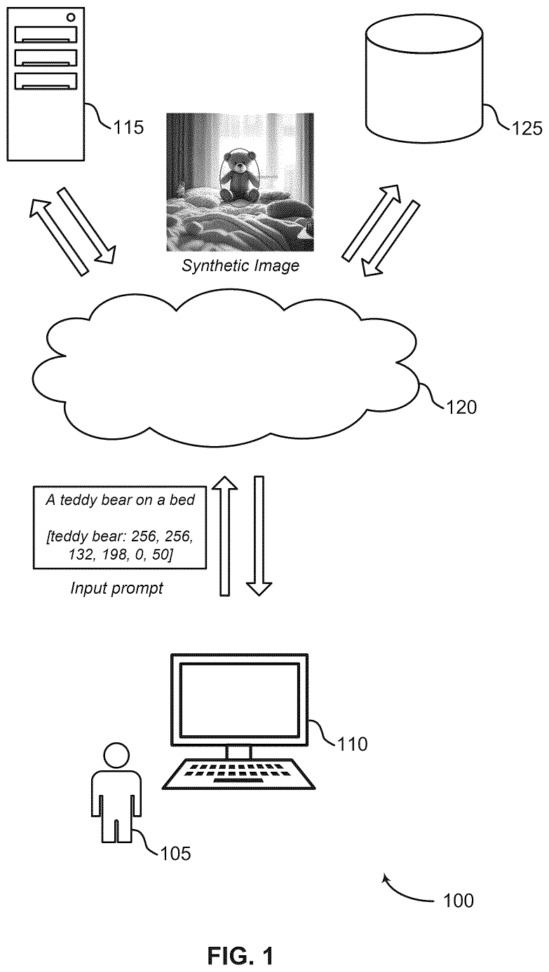

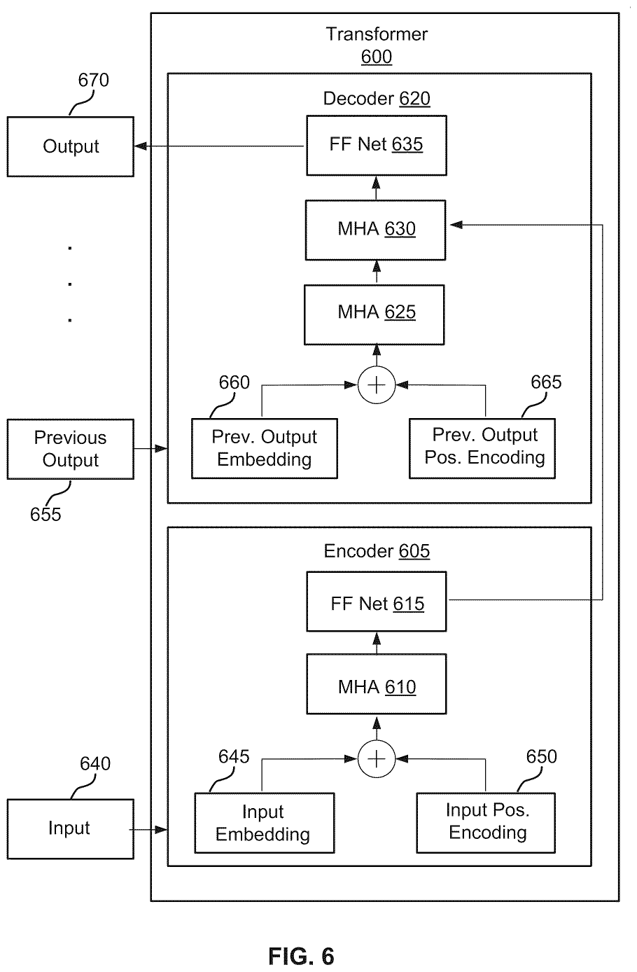

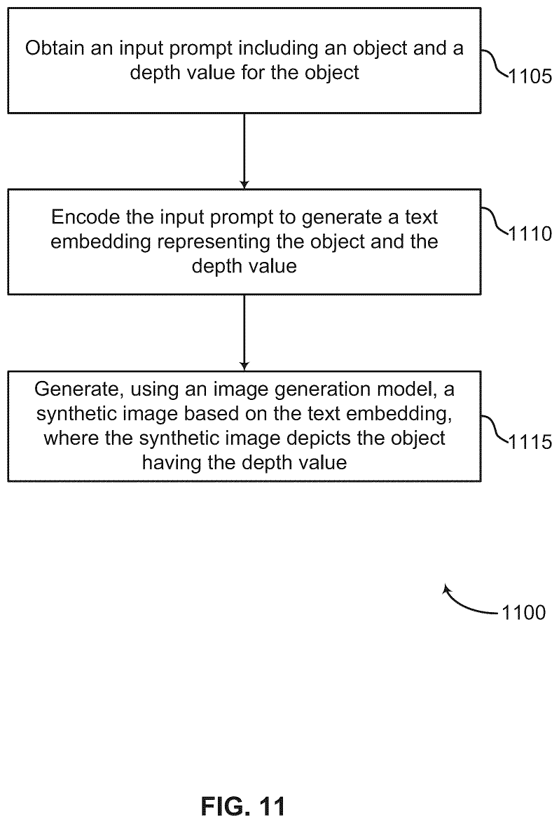

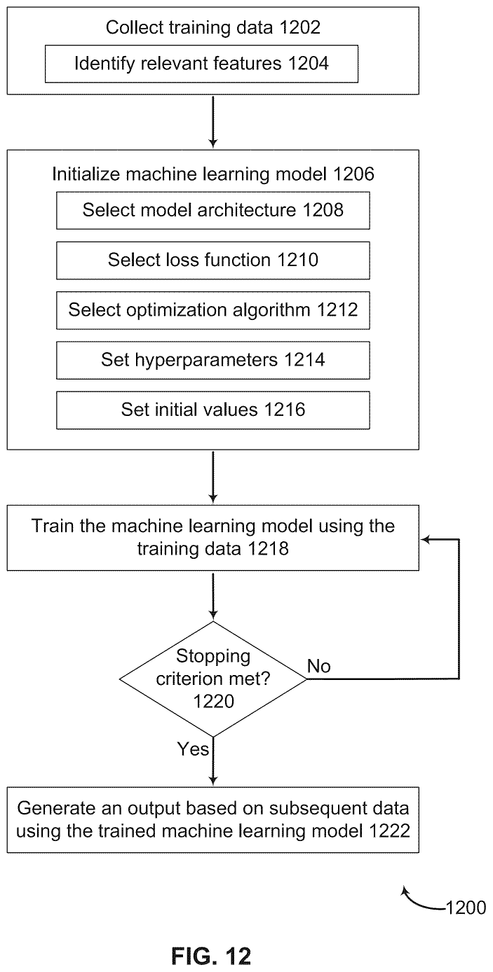

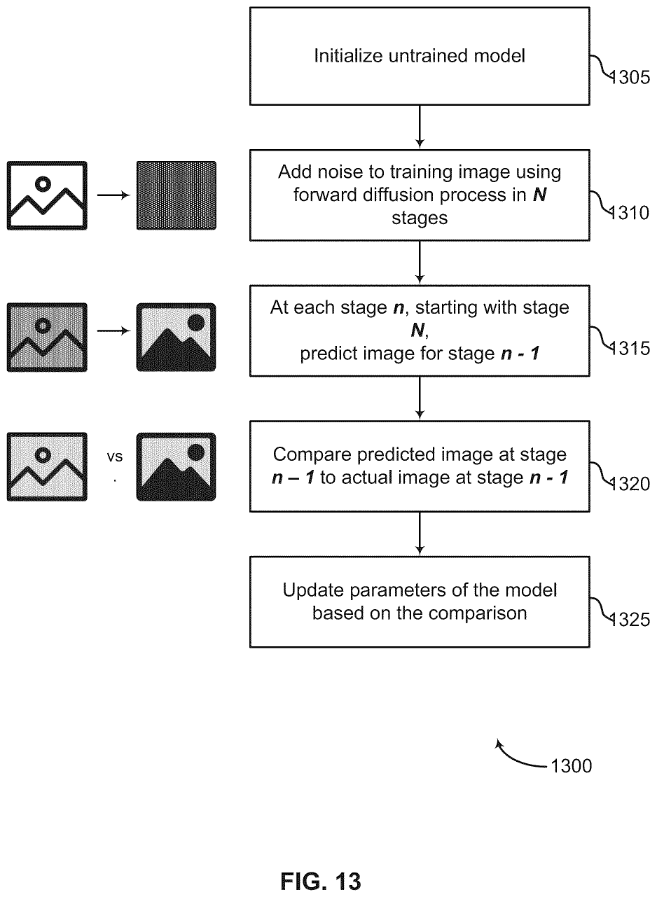

Embodiments of the present disclosure can be implemented in an image processing system. For example, the image processing system of the present disclosure takes an input prompt (e.g., describing an element and a location of the element in the image to be generated) and generates an image that accurately depicts the element at the location provided by the input prompt. Example applications regarding generating an image are provided with reference to FIGS. 1-5. Details regarding the architecture of the image generation model are provided with reference to FIGS. 6-10 and 14-15. Details regarding an operation of the image generation model are provided with reference to FIG. 11. Examples of a process for training the image generation model are provided with reference to FIGS. 12-13.

### Image Generation System

A system and an apparatus for image processing are described with reference to FIGS. 1-10. FIG. 1 shows an example of an image processing system 100 according to aspects of the present disclosure. In one aspect, image processing system 100 includes user 105, user device 110, image processing apparatus 115, cloud 120, and database 125.

In the example of FIG. 1, user provides a prompt with location information to image processing apparatus 115 via a user interface provided on user device 110 by image processing apparatus 115. In some examples, the input prompt refers to a text-based (i.e., a natural language based) prompt. As shown in FIG. 1, the input prompt describes an element and location information associated with the element based on which the user wants to generate an image using the image processing apparatus 115 of the present disclosure.

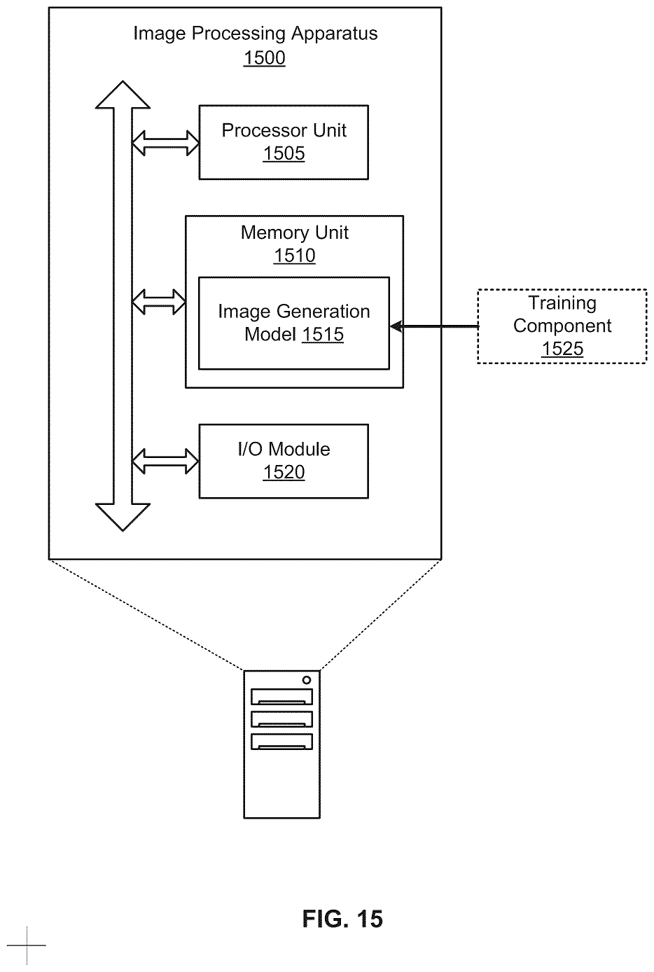

In some cases, the image processing apparatus 115 implements an image generation model (such as the image generation model 1515 described with reference to FIG. 15) to generate a synthetic image that depicts the element described in the input prompt at the location provided in the input prompt. For example, as shown in FIG. 1, the user provides an input prompt (e.g., a text query and associated location information) to the image processing apparatus 115, for which the user wants to generate an image. In some examples, the image processing apparatus 115 generates an image that accurately depicts the information provided by the input prompt.

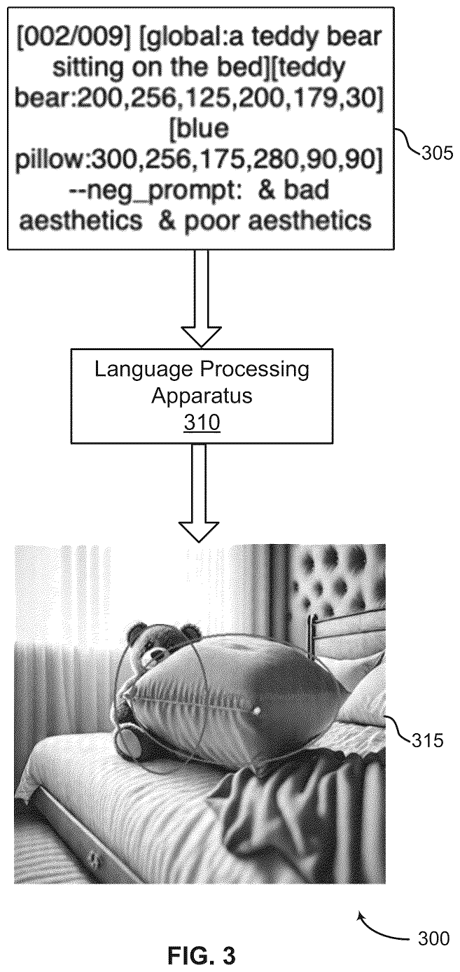

Image processing apparatus 115 provides for generation of a high-quality synthetic image with precise object control. In some cases, the image processing apparatus 115 takes an input prompt and location information (e.g., spatial location and depth disparity value of the element) as input and generates a synthetic image that incorporates each aspect of the input prompt and the location information. Image processing apparatus 115 is an example of, or includes aspects of, the corresponding element described with reference to FIGS. 3-5.

Referring again to the example of FIG. 1, the image processing apparatus 115 generates the synthetic image that accurately depicts the element described by the input prompt. According to some aspects, user device 110 is a personal computer, laptop computer, mainframe computer, palmtop computer, personal assistant, mobile device, or any other suitable processing apparatus. In some examples, user device 110 includes software that displays a user interface (e.g., a graphical user interface) provided by image processing apparatus 115. In some aspects, the user interface provides for information (such as text, images (an input image or an input query), video, a prompt, a canvas, etc.) to be communicated between user 105 and image processing apparatus 115.

According to some aspects, a user device user interface enables user 105 to interact with user device 110. In some embodiments, the user device user interface may include an audio device, such as an external speaker system, an external display device such as a display screen, or an input device (e.g., a remote-control device interfaced with the user interface directly or through an I/O controller module). In some cases, the user device user interface may be a graphical user interface.

According to some aspects, image processing apparatus 115 includes a computer-implemented network. In some embodiments, the computer-implemented network includes an image generation model (such as the image generation model described with reference to at least FIGS. 6-10). In some embodiments, image processing apparatus 115 also includes one or more processors, a memory subsystem, a communication interface, an I/O interface, one or more user interface components, and a bus as described with reference to FIG. 11. Additionally, in some embodiments, image processing apparatus 115 communicates with user device 110 and database 125 via cloud 120.

In some cases, image processing apparatus 115 is implemented on a server. A server provides one or more functions to users linked by way of one or more of various networks, such as cloud 120. In some cases, the server includes a single microprocessor board, which includes a microprocessor responsible for controlling all aspects of the server. In some cases, the server uses microprocessor and protocols to exchange data with other devices or users on one or more of the networks via hypertext transfer protocol (HTTP), and simple mail transfer protocol (SMTP), although other protocols such as file transfer protocol (FTP), and simple network management protocol (SNMP) may also be used. In some cases, the server is configured to send and receive hypertext markup language (HTML) formatted files (e.g., for displaying web pages). In various embodiments, the server includes a general-purpose computing device, a personal computer, a laptop computer, a mainframe computer, a supercomputer, or any other suitable processing apparatus.

Cloud 120 is a computer network configured to provide on-demand availability of computer system resources, such as data storage and computing power. In some examples, cloud 120 provides resources without active management by a user. The term “cloud” is sometimes used to describe data centers available to many users over the Internet. Some large cloud networks have functions distributed over multiple locations from central servers. A server is designated an edge server if it has a direct or close connection to a user. In some cases, cloud 120 is limited to a single organization. In other examples, cloud 120 is available to many organizations. In one example, cloud 120 includes a multi-layer communications network including multiple edge routers and core routers. In another example, cloud 120 is based on a local collection of switches in a single physical location. According to some aspects, cloud 120 provides communications between user device 110, image processing apparatus 115, and database 125.

Database 125 is an organized collection of data. In an example, database 125 stores data in a specified format known as a schema. According to some aspects, database 125 is structured as a single database, a distributed database, multiple distributed databases, or an emergency backup database. In some cases, a database controller manages data storage and processing in database 125. In some cases, a user interacts with the database controller. In other cases, the database controller operates automatically without interaction from the user. According to some aspects, database 125 is external to image processing apparatus 115 and communicates with image processing apparatus 115 via cloud 120. According to some aspects, database 125 is included in image processing apparatus 115.

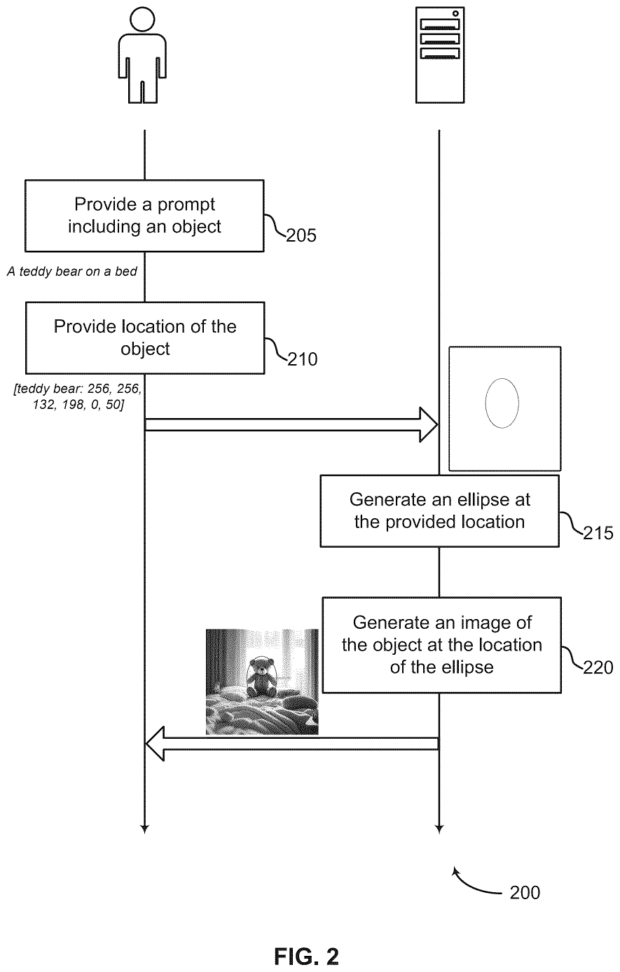

FIG. 2 shows an example of a method 200 for image generation according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

According to an embodiment of the present disclosure, an image processing apparatus (such as the image processing apparatus described with reference to FIGS. 1-5 and 14-15) provides an image generation model (such as the image generation model described with reference to FIGS. 6-10) that accurately generates an image in response to the input prompt.

At operation 205, the system provides a prompt including an object. In some cases, the operations of this step refer to, or may be performed by, a user as described with reference to FIG. 1.

At operation 210, the system provides position of the object. In some cases, the operations of this step refer to, or may be performed by, a user as described with reference to FIG. 1.

In some cases, the user-provided text query describes an element and a location of the element, based on which the user wants to generate an image. For example, the user provides a text prompt instructing the image processing apparatus to generate an image that accurately aligns with the prompt. As shown in FIG. 2, the user provides a prompt including a natural language description of an element such as “A teddy bear on a bed” and location information associated with the element such as “[teddy bear: 256, 256, 132, 198, 0, 50]” to the language processing apparatus via a user interface of a user device (such as a user interface of user device 110 described with reference to FIG. 1).

At operation 215, the system generates an ellipse at the provided location. In some cases, the operations of this step refer to, or may be performed by, an image processing apparatus as described with reference to FIGS. 1, and 3-5.

In some cases, the image processing apparatus includes an image generation model that generates an ellipse at the location of the element provided in the prompt. For example, the image generation model specifies an ellipse corresponding to the location of the object in the synthetic image. In some examples, the spatial arrangement of the element in the image to be generated is encoded as the ellipse. Additionally, for example, the ellipse is defined using parameters (such as location information obtained at operation 210) provided by the input prompt.

At operation 220, the system generates an image with the object at the position. In some cases, the operations of this step refer to, or may be performed by, an image processing apparatus as described with reference to FIGS. 1, and 3-5.

In some cases, the image generation model generates the image (such as the synthetic image described with reference to FIGS. 1 and 3-5) based on the ellipse. For example, the generated image depicts the element provided at operation 205 at the location provided at operation 210 (i.e., location of the ellipse). The image generation model integrates the element (e.g., “teddy bear”) in the generated image based on a position information of the ellipse. The generated image is provided to the user via a user interface of the user device (such as user device 110 as described in FIG. 1). Further details regarding the generation of the image are provided with reference to at least FIGS. 3-5 and 11.

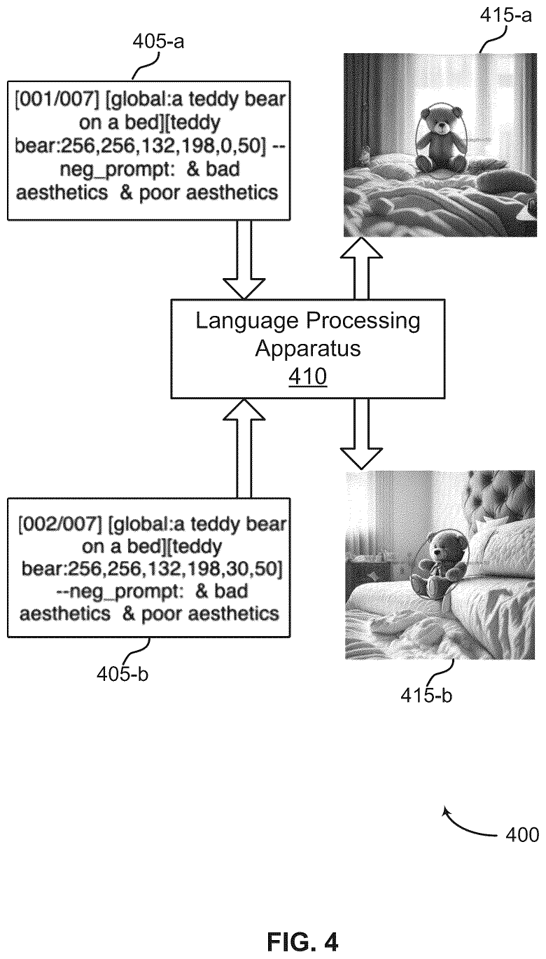

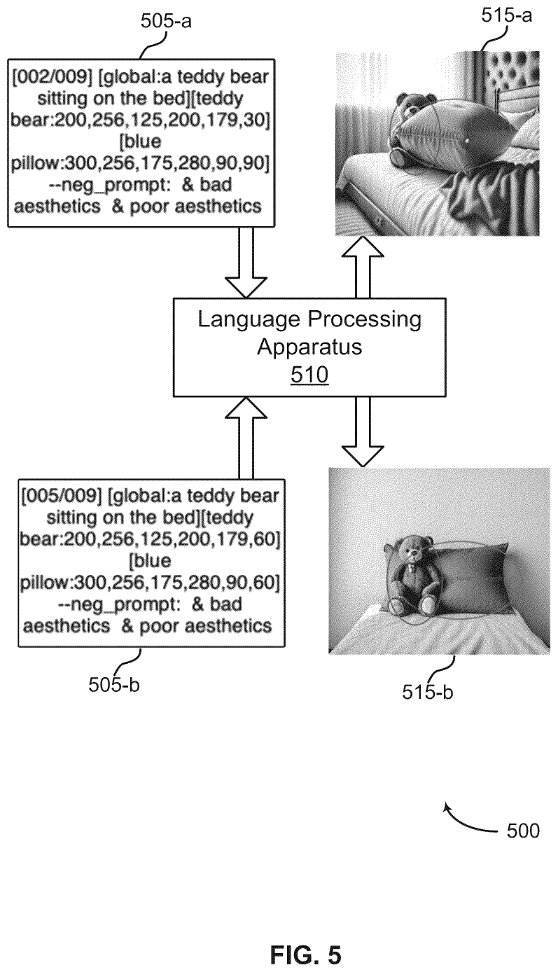

FIG. 3 shows an example of an image generation process 300 according to aspects of the present disclosure. Image generation process 300 is an example of, or includes aspects of, the corresponding element described with reference to FIGS. 4 and 5. In one aspect, image generation process 300 includes input prompt 305, image processing apparatus 310, and synthetic image 315.

According to an embodiment, user (such as user 105 described with reference to FIG. 1) provides an input prompt (such as input prompt described with reference to FIGS. 1-2). In some cases, the input prompt includes a description of an element and location information associated with the element. In some examples, input prompt 305 is a natural language prompt based on which the user wants to generate the synthetic image.

In some cases, a user provides an input prompt including description of an element and the associated location information to image processing apparatus 310 via a user interface of the image processing apparatus 310. For example, as shown in FIG. 3, a user provides an input prompt 305 including description of an element (i.e., teddy bear) as “a teddy bear sitting on the bed” and location information associated with the element as “teddy bear: 200, 256, 125, 200, 179, 30” to image processing apparatus 310.

As used herein, the location information indicates spatial arrangement and depth information of the element within the synthetic image 315. In some cases, the spatial arrangement of the element in an image is encoded as an ellipse. For example, the depth of the element includes depth disparity value for a centroid location associated with the element. Input prompt 305 is an example of, or includes aspects of, the corresponding element described with reference to FIGS. 4 and 5.

The image processing apparatus 310 (such as the image processing apparatus described with reference to at least FIGS. 1-2, 4-5, and 15) of the present disclosure receives the input prompt including the spatial arrangement and depth information of the element from the user. In some cases, the image processing apparatus 310 generates synthetic image 315 based on the ellipse and the description of the element.

In some cases, image processing apparatus 310 includes a text encoder and an image generation model (such as the image generation model described with reference to FIGS. 6-10). For example, the text encoder takes the input prompt (such as a text prompt), the ellipse information (e.g., ellipse corresponding to the teddy bear based on parameters including centroid of the ellipse (i.e., 256, 256), axis lengths of the ellipse (i.e., 132, 198), and an orientation of the ellipse (i.e., 0)), and depth information (e.g., z-ordering, i.e., 50) as input and accurately generates an embedding based on encoding the input prompt, the ellipse, and the depth information.

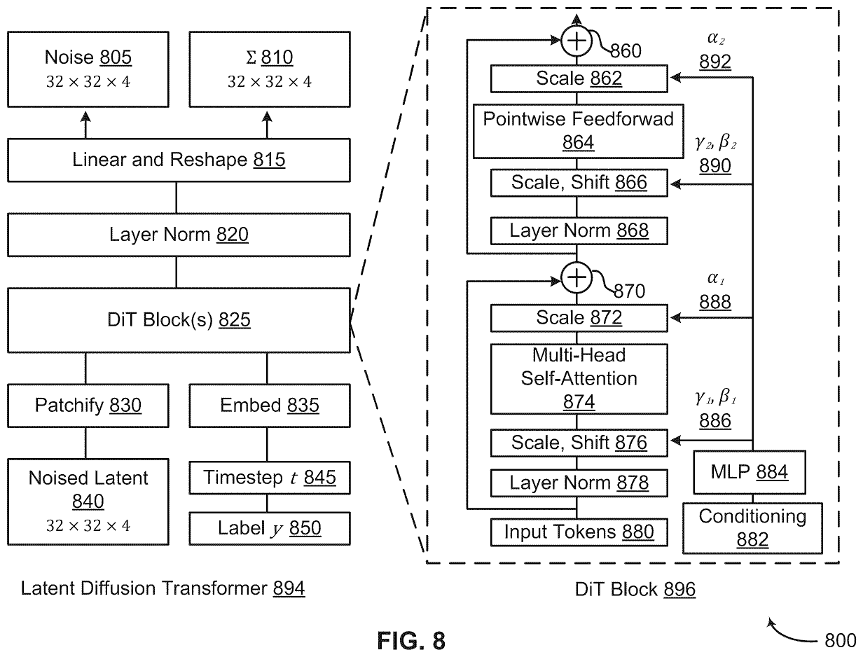

According to an embodiment, the image generation model of image processing apparatus 310 includes a diffusion transformer architecture (such as the diffusion transformer described with reference to FIG. 8) that generates synthetic image 315 in a single step based on the generated embedding. Image processing apparatus 310 is an example of, or includes aspects of, the corresponding element described with reference to FIGS. 1, 4, and 5. Synthetic image 315 is an example of, or includes aspects of, the corresponding element described with reference to FIGS. 4 and 5.

FIG. 4 shows an example of an image generation process 400 with orientation control according to aspects of the present disclosure. Image generation process 400 is an example of, or includes aspects of, the corresponding element described with reference to FIGS. 3 and 5. In one aspect, image generation process 400 includes input prompt 405, image processing apparatus 410, and synthetic image 415.

Embodiments of the present disclosure include an image generation model. In some cases, the image generation model changes an orientation of an element provided by the input prompt. For example, the image generation model changes the orientation of the element by a parameter (e.g., a single parameter) in the ellipse information (such as the ellipse information described in FIGS. 1-3). In some examples, a single parameter is changed to obtain different orientations for a given element.

According to an embodiment, user (such as user 105 described with reference to FIG. 1) provides an input prompt (such as input prompt described with reference to FIGS. 1-2). In some cases, the input prompt includes a description of an element and a location associated with the element. In some examples, input prompt 405 is a natural language prompt based on which the user wants to generate the synthetic image.

In some cases, a user provides an input prompt comprising description of an element and the associated location information to image processing apparatus 410 via a user interface of the image processing apparatus 410. For example, as shown in FIG. 4, a user provides an input prompt 405-a comprising description of an element (i.e., teddy bear) as “a teddy bear sitting on the bed” and location information associated with the element as “teddy bear: 256, 256, 132, 198, 0, 50” to image processing apparatus 410.

As described with reference to FIG. 4, the location information corresponding to input prompt 405-a indicates parameters including centroid of the ellipse (e.g., 256, 256), axis lengths of the ellipse (corresponding to the major and minor axis of the ellipse, e.g., 132, 198), an orientation of the ellipse (e.g., 0), and a depth information of the ellipse (depth disparity value for a centroid location of the element, e.g., 50) for generating the synthetic image 415-a. Similarly, as shown in FIG. 4, the location information corresponding to input prompt 405-b indicates parameters including centroid of the ellipse (e.g., 256, 256), axis lengths of the ellipse (corresponding to the major and minor axis of the ellipse, e.g., 132, 198), an orientation of the ellipse (e.g., 30), and a depth information of the ellipse (depth disparity value for a centroid location of the element, e.g., 50) for generating the synthetic image 415-b.

Image processing apparatus 410 (such as the image processing apparatus described with reference to at least FIGS. 1-2, 4-5, and 15) of the present disclosure receives the input prompt from the user. In some cases, the image processing apparatus 410 comprises an image generation model (such as the image generation model described with reference to FIGS. 6-10) that generates synthetic image 415-a and 415-b based on the input prompts 405-a and 405-b, respectively.

In some cases, a text encoder of image processing apparatus 410 generates an embedding based on encoding the input prompt 405. Subsequently, an image generation model of image processing apparatus 410 generates synthetic image 415 in a single step based on the generated embedding. Input prompt 405 is an example of, or includes aspects of, the corresponding element described with reference to FIGS. 3 and 5. Image processing apparatus 410 is an example of, or includes aspects of, the corresponding element described with reference to FIGS. 1, 3, and 5. Synthetic image 415 is an example of, or includes aspects of, the corresponding element described with reference to FIGS. 3 and 5.

Accordingly, image processing apparatus 410 generates synthetic image 415-a based on an orientation of the ellipse (e.g., 0). Additionally, image processing apparatus 410 generates synthetic image 415-b based on a different orientation of the ellipse (e.g., 30). By changing a parameter (e.g., a single parameter associated with the orientation of the ellipse), embodiments of the present disclosure are able to change the orientation of the element (i.e., “teddy bear”) described by input prompt.

FIG. 5 shows an example of an image generation process 500 with ordering control according to aspects of the present disclosure. Image generation process 500 is an example of, or includes aspects of, the corresponding element described with reference to FIGS. 3 and 4. In one aspect, image generation process 500 includes input prompt 505, image processing apparatus 510, and synthetic image 515.

Embodiments of the present disclosure include an image generation model configured to generate an image comprising an element based on an input prompt. In some cases, the image generation model changes a z-ordering of the element. In some cases, the image generation model changes the z-order for a first element and a second element in an image. For example, the image generation model changes the z-order for a teddy bear and a pillow, e.g., the image generation model swaps the z-order or placement of the teddy bear and the pillow in the image.

According to an embodiment, user (such as user 105 described with reference to FIG. 1) provides an input prompt (such as input prompt described with reference to FIGS. 1-2). In some cases, the input prompt comprises a description of an element and a location associated with the element. In some examples, input prompt 505 is a natural language prompt based on which the user wants to generate the synthetic image.

In some cases, a user provides an input prompt comprising description of an element and the associated location information to image processing apparatus 510 via a user interface of the image processing apparatus 510. For example, as shown in FIG. 5, a user provides an input prompt 505-a comprising description of an element (i.e., teddy bear) as “a teddy bear sitting on the bed” and location information associated with the element to image processing apparatus 510.

As described with reference to FIG. 5, the location information corresponding to input prompt 505-a indicates parameters including centroid of the ellipse (e.g., 200, 256), axis lengths of the ellipse (corresponding to the major and minor axis of the ellipse, e.g., 125, 200), an orientation of the ellipse (e.g., 179), and a depth information of the ellipse (depth disparity value for a centroid location of the element, e.g., 30) associated with the teddy bear in the synthetic image 515-a. Additionally, the location information corresponding to input prompt 505-a indicates parameters including centroid of the ellipse (e.g., 300, 256), axis lengths of the ellipse (corresponding to the major and minor axis of the ellipse, e.g., 175, 280), an orientation of the ellipse (e.g., 90), and a depth information of the ellipse (depth disparity value for a centroid location of the element, e.g., 90) associated with the blue pillow in the synthetic image 515-a.

Similarly, as shown in FIG. 5, the location information corresponding to input prompt 505-b indicates parameters including centroid of the ellipse (e.g., 200, 256), axis lengths of the ellipse (corresponding to the major and minor axis of the ellipse, e.g., 125, 200), an orientation of the ellipse (e.g., 179), and a depth information of the ellipse (depth disparity value for a centroid location of the element, e.g., 60) associated with the teddy bear in the synthetic image 515-b. Additionally, the location information corresponding to input prompt 505-b indicates parameters including centroid of the ellipse (e.g., 300, 256), axis lengths of the ellipse (corresponding to the major and minor axis of the ellipse, e.g., 175, 280), an orientation of the ellipse (e.g., 90), and a depth information of the ellipse (depth disparity value for a centroid location of the element, e.g., 60) associated with the blue pillow in the synthetic image 515-b.

In some cases, a text encoder of image processing apparatus 510 generates an embedding based on encoding the input prompt 505. Image processing apparatus 510 (such as the image processing apparatus described with reference to at least FIGS. 1-2, 4, 6, and 15) of the present disclosure receives the input prompt from the user. Subsequently, an image generation model (such as the image generation model described with reference to FIGS. 6-10) of image processing apparatus 510 generates synthetic image 515 in a single step based on the generated embedding. For instance, the image generation model generates synthetic images 515-a and 515-b based on the input prompts 505-a and 505-b, respectively.

Input prompt 505 is an example of, or includes aspects of, the corresponding element described with reference to FIGS. 3 and 4. Image processing apparatus 510 is an example of, or includes aspects of, the corresponding element described with reference to FIGS. 1, 3, and 4. Synthetic image 515 is an example of, or includes aspects of, the corresponding element described with reference to FIGS. 3 and 4.

Accordingly, image processing apparatus 510 generates synthetic image 515 based on depth information. As shown in FIG. 5, image processing apparatus 510 generates synthetic image 515 based on changing depth information (i.e., z-order) of the ellipse corresponding to the teddy bear (e.g., 30 in input prompt 505-a to 60 in input prompt 505-b) and the ellipse corresponding to the blue pillow (e.g., 90 in input prompt 505-a to 60 in input prompt 505-b). By changing a parameter (e.g., a single parameter associated with the depth information or ordering of the ellipse), embodiments of the present disclosure are able to change the z-ordering of the elements (i.e., “teddy bear” and “blue pillow”) described by input prompt 505.

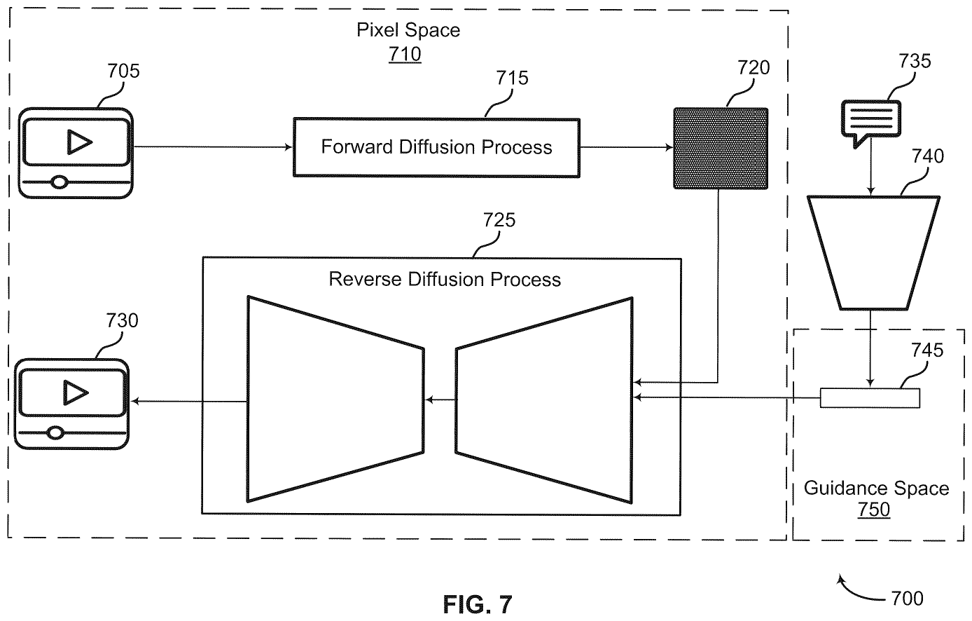

FIG. 6 shows example of a transformer network 600 according to aspects of the present disclosure. The example shown includes transformer 600, encoder 605, decoder 620, input 640, input embedding 645, input positional encoding 650, previous output 655, previous output embedding 660, previous output positional encoding 665, and output 670. According to some aspects, encoder 605 is implemented as a video encoder of a multi-modal encoder. According to some aspects, encoder 605 is implemented as a text encoder of conditional text encoder. According to some aspects, transformer 600 is implemented in the panel of peer model (such as the image generation model described with reference to FIGS. 7-10).

In some cases, encoder 605 includes multi-head self-attention sublayer 610 and feed-forward network sublayer 615. In some cases, decoder 620 includes first multi-head self-attention sublayer 625, second multi-head self-attention sublayer 630, and feed-forward network sublayer 635.

In some cases, encoder 605 is configured to map input 640 (for example, a text prompt) to a sequence of continuous representations that are fed into decoder 620. In some cases, decoder 620 generates output 670 (e.g., a prediction of an output sequence of words or tokens) based on the output of encoder 605 and previous output 655 (e.g., a previously predicted output sequence), which allows for the use of autoregression.

For example, in some cases, encoder 605 parses input 640 into tokens and vectorizes the parsed tokens to obtain input embedding 645, and adds input positional encoding 650 (e.g., positional encoding vectors for input 640 of a same dimension as input embedding 645) to input embedding 645. In some cases, input positional encoding 650 includes information about relative positions of words or tokens in input 640.

In some cases, encoder 605 comprises one or more encoding layers that generate contextualized token representations, where each representation corresponds to a token that combines information from other input tokens via self-attention mechanism. In some cases, each encoding layer of encoder 605 comprises a multi-head self-attention sublayer (e.g., multi-head self-attention sublayer 610). In some cases, the multi-head self-attention sublayer implements a multi-head self-attention mechanism that receives different linearly projected versions of queries, keys, and values to produce outputs in parallel. In some cases, each encoding layer of encoder 605 also includes a fully connected feed-forward network sublayer (e.g., feed-forward network sublayer 615) comprising two linear transformations surrounding a Rectified Linear Unit (ReLU) activation:

$$FFN ( x ) = ReLU ( {W}_{1} x + {b}_{1} ) {W}_{2} + {b}_{2} \qquad ( 1 )$$

In some cases, each layer employs different weight parameters (W₁, W₂) and different bias parameters (b₁, b₂) to apply a same linear transformation each word or token in input 640.

In some cases, each sublayer of encoder 605 is followed by a normalization layer that normalizes a sum computed between a sublayer input x and an output sublayer (x) generated by the sublayer:

layernorm(x+sublayer(x)) (2)

In some cases, encoder 605 is bidirectional because encoder 605 attends to each word or token in input 640 regardless of a position of the word or token in input 640.

According to some aspects, encoder 605 functions as a text encoder of the conditional text encoder. In an example, conditional text encoder splits an input text into fixed-size segments, generates a linear embedding of each of the segments, adds position embeddings to each of the linear embeddings, and provides the resulting sequence of vectors as input 640 to encoder 605.

In some cases, decoder 620 comprises one or more decoding layers (e.g., six decoding layers). In some cases, each decoding layer comprises three sublayers including a first multi-head self-attention sublayer (e.g., first multi-head self-attention sublayer 625), a second multi-head self-attention sublayer (e.g., second multi-head self-attention sublayer 630), and a feed-forward network sublayer (e.g., feed-forward network sublayer 635). In some cases, each sublayer of decoder 620 is followed by a normalization layer that normalizes a sum computed between a sublayer input x and an output sublayer (x) generated by the sublayer.

In some cases, decoder 620 generates previous output embedding 660 of previous output 655 and adds previous output positional encoding 665 (e.g., position information for words or tokens in previous output 655) to previous output embedding 660. In some cases, each first multi-head self-attention sublayer receives the combination of previous output embedding 660 and previous output positional encoding 665 and applies a multi-head self-attention mechanism to the combination. In some cases, for each word in an input sequence, each first multi-head self-attention sublayer of decoder 620 attends only to words preceding the word in the sequence, and so a prediction of transformer 600 for a word at a particular position only depends on known outputs for a word that came before the word in the sequence. For example, in some cases, each first multi-head self-attention sublayer implements multiple single-attention functions in parallel by introducing a mask over values produced by the scaled multiplication of matrices Q and K by suppressing matrix values that would otherwise correspond to disallowed connections.

In some cases, each second multi-head self-attention sublayer implements a multi-head self-attention mechanism similar to the multi-head self-attention mechanism implemented in each multi-head self-attention sublayer of encoder 605 by receiving a query Q from a previous sublayer of decoder 620 and a key K and a value V from the output of encoder 605, allowing decoder 620 to attend to each word in the input 640.

In some cases, each feed-forward network sublayer implements a fully connected feed-forward network similar to feed-forward network sublayer 615. In some cases, the feed-forward network sublayers are followed by a linear transformation and a softmax to generate a prediction of output 670.

FIG. 7 shows an example of a guided diffusion model 700 according to aspects of the present disclosure. In some examples, guided diffusion model 700 describes the operation and architecture of the image generation model 1515 described with reference to FIG. 15. The guided latent diffusion model 700 depicted in FIG. 7 is an example of, or includes aspects of, a media generation model as described herein.

Diffusion models are a class of generative neural networks which can be trained to generate new data with features similar to features found in training data. In particular, diffusion models can be used to generate novel media items such as images, audio files, videos, three-dimensional (3D) models or other digital media items. Diffusion models can be used for various media processing tasks including image super-resolution, generation of media items with perceptual metrics, conditional generation (e.g., generation based on text guidance), image inpainting, and media manipulation.

Diffusion models work by iteratively adding noise to the data during a forward process and then learning to recover the data by denoising the data during a reverse process. For example, during training, guided latent diffusion model 700 may take an original media item 705 in a pixel space 710 as input and apply forward diffusion process 715 to gradually add noise to the original media item 705 to obtain noisy media item 720 at various noise levels.

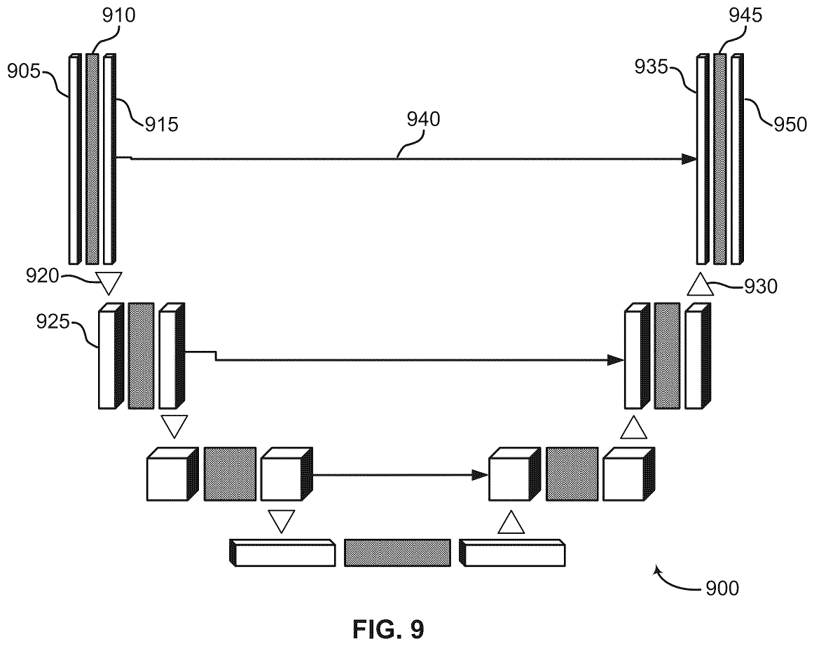

Next, a reverse diffusion process 725 (e.g., a diffusion transformer network described in FIG. 8 or a U-Net described in FIG. 9) gradually removes the noise from the noisy media item 720 at the various noise levels to obtain an output media item 730. In some cases, an output media item 730 is created from each of the various noise levels. The output media item 730 can be compared to the original media item 705 to train the reverse diffusion process 725.

The reverse diffusion process 725 can also be guided based on a text prompt 735, or another guidance prompt, such as an image, a layout, a segmentation map, etc. The text prompt 735 can be encoded using a text encoder 765 (e.g., a multimodal encoder) to obtain guidance features 745 in guidance space 750. The guidance features 745 can be combined with the noisy media item 720 at one or more layers of the reverse diffusion process 725 to ensure that the output media item 730 includes content described by the text prompt 735. For example, guidance features 745 can be combined with the noisy features using a cross-attention block within the reverse diffusion process 725.

Methods of operating diffusion models include a Denoising Diffusion Probabilistic Model (DDPM) and a Denoising Diffusion Implicit Models (DDIM). In DDPM, the generative process includes reversing a stochastic Markov diffusion process. DDIMs, on the other hand, use a deterministic process so that the same input results in the same output. In some cases, DDIM can reduce the number of timesteps during media generation. Diffusion models may also be characterized by whether the noise is added to the media item itself, or to media features generated by an encoder (i.e., latent diffusion). In a pixel diffusion model, noise is added and removed in pixel space. In a latent diffusion model, the noise is added (and removed) in a latent space of media features rather than in pixel space. Thus, a latent diffusion model generates media features using reverse diffusion, and these media features can be decoded to obtain a synthetic media item.

FIG. 8 shows an example of a diffusion transformer (DiT) architecture 800 according to aspects of the present disclosure. The example shown includes predicted noise 805, predicted covariance 810, linear and reshape layers 815, normalization layer 820, DiT block(s) 825, patchify operation 830, embedding 835, noised latent 840, timestep information 845, label information 850, and an implementation of one block in the DiT block(s) 825 by a DiT Block 896. The DiT Block 896 includes: second residual connection 860, second scaling operations 862, feed-forward network 864, post-normalization second scaling and shifting 866, second normalization 868, first residual connection 870, first scaling operations 872, self-attention 874, post-normalization first scaling and shifting 876, first normalization 878, input tokens 880, conditioning tokens 882, multi-layer perceptron (MLP) 884, post-normalization first scaling and shifting parameters 886, first scaling parameter 888, post-normalization second scaling and shifting parameters 890, and second scaling parameter 892. In some embodiments, the architecture employes an Latent Diffusion Transformer 894. In some embodiments, DiT Block 896 employs an “adaLN-Zero” technique.

Diffusion Transformers (DiTs) is a popular architecture for diffusion models and is designed to be structurally faithful to standard transformer architecture. DiT incorporates transformer structures' scaling properties. For training denoising diffusion probabilistic models (DDPMs) of images (e.g., spatial representations of images), DiT is based on a Vision Transformer (ViT) architecture which operates on sequences of patches. DiT processes images by dividing them into patches, converting these patches into tokens, and applying attention mechanisms to model relationships between different regions of the image. This approach allows the model to capture both local and long-range dependencies in the image generation process.

In some cases, input to DiT is a spatial representation z. For 256×256×3 images, z has shape 32×32×4. A first layer of a DiT is to carry out patchify operation, where the DiT divides an input image into patches and converts the patches (a form of spatial input) into a sequence of T tokens, each of dimension d, by linearly embedding each patch in the input. Following the patchify process, ViT frequency-based positional embeddings are applied to all input tokens. In some cases, the number of tokens T created by patchify is determined by a patch size hyper-parameter p. In some cases, T=(I/p)², where I is another shape parameter, thus halving p will quadruple T, which in some cases at least quadruples total of transformer Giga Floating Point Operations (Gflops). In some examples, changing p has no impact on downstream parameter counts, i.e., parameter counts in downstream layers of DiT is independent from p. In some examples, p=2, 4 or 8. Various patch sizes, transformer block architectures and model sizes are implemented.

Following Patchify operation, attention mechanisms are applied to model relationships between different regions of the image in one or more DiT blocks. In addition to noised image inputs, diffusion models sometimes process additional conditional information such as noise timesteps t, class labels c, natural language information, etc. Four variants of transformer blocks for processing conditional inputs including both input information and conditional information are described below.

In some cases, DiT blocks in the DiT network are implemented using adaptive layer norm (adaLN) blocks. Following adaptive normalization layers in generative adversarial networks (GANs) and conventional diffusion models with U-Net backbones, in some examples, standard normalization layers in transformer blocks are replaced with adaptive layer norm (adaLN). Rather than directly learning dimension-wise scale γ and shift parameters β, in adaLN the system regresses γ and β from a sum of the embedding vectors of the noise timesteps t and the class labels c. An adaLN adds relatively small numbers of Gflops and is more efficient. Additionally, adaLN is a conditioning mechanism that applies a same function to all tokens.

In some cases, DiT blocks in the DiT network are implemented using adaLN-Zero blocks, which leverages zero-initialization techniques. In Residual Networks (ResNets), initializing each residual block as the identity function x→x is beneficial. In some examples, zero-initializing a final batch norm scale factor γ in each block accelerates large-scale training in supervised learning settings. Diffusion models based on U-Nets use a similar initialization strategy, zero-initializing final convolutional layer in each block prior to residual connections. An adaLN-Zero block is modified from an adaLN block using similar zero-initialization techniques. In addition to regressing the dimension-wise scale γ and the shifting parameters β, the system also regresses dimension-wise scaling parameters as that are applied immediately prior to residual connections within the DiT block. The network initializes a multi-layer perceptron (MLP) to output a zero-vector for all as; this initializes an entire DiT block as the identity function. As with the adaLN block, adaLNZero adds negligible Gflops to the model.

In some cases, DiT blocks in the DiT network are implemented using in-context conditioning, where vector embeddings of t and c are appended as two additional tokens in the input sequence, and after a final block, the network removes the two conditioning tokens from the sequence.

In some cases, DiT blocks in the DiT network include cross-attention blocks. The DiT network concatenates the embeddings of t and c into a length-two sequence, separate from the image token sequence. The transformer block is modified to include an additional multi-head cross-attention layer following the multi-head self-attention block.

In some cases, the DiT network includes a sequence of N DiT blocks, each operating at a hidden dimension size d. Following ViT, the DiT network uses standard transformer configs that jointly scale N, d and attention heads. In some examples, Small(S), Base (B), Large (L) variants, XLarge (XL) variants of model sizes are implemented. Small or Base model sizes have N=12 layers of DiT blocks, Large model sizes have 24 layers of DiT blocks. XLarge model sizes have 28 layers of DiT blocks.

After a final DiT block, the DiT network decodes the sequence of image tokens into an output noise prediction and an output diagonal covariance prediction. Both outputs have shape equal to an original spatial input. Standard linear decoder is utilized to decode, wherein a final normalization layer (or adaptive normalization layer if the DiT block is an adaLN block) and linearly decode each token into a p×p×2C tensor, where C is a number of channels in the spatial input to the DiT network and p is the patch size hyperparameter. Finally, decoded tokens are rearranged into their original spatial layout to get the predicted noise and covariance.

The architecture 800, in some cases, employs a Latent Diffusion Transformer 894. The architecture 800 processes noised latent 840, which may be a noised version of an input image encoded in a latent space. Patchify operation 830 divides the noised latent into a sequence of patches that are processed as tokens. The tokens are vector representations of each patch of the image in latent space and are adjusted through attention processes. Each of the tokens also receives timestep information 845 and label information 850 and, accordingly, their embedding 835, which encodes the current denoising timestep and class labels as conditional information. In some cases, embedding 835 is referred to as conditional embedding or conditional information embedding. In some cases, a positional embedding which encodes each token's spatial position in the image is applied to the patchified input tokens at the patchify operations 830. In some examples the positional embedding is ViT frequency-based positional embedding. The input tokens 880 generated by the patchify operation 830 and the conditioning tokens 882 generated by the embedding 835 are processed through N DiT block(s) 825, where N may be 12, 24 or 28. Other values of N may be used. In some cases, conditional tokens refer to tokens generated based on embedding 835 encoding timestep information 845 and label information 850.

Each of the DiT block(s) 825 includes multiple processing stages. DiT Block 896 illustrates an embodiment of one block in the DiT block(s) 825. In some embodiments, the DiT Block 896 is an example of, or includes aspects of, the adaLN-Zero block. In some cases, input tokens 880 interact with the conditioning tokens 882 through multiple attention mechanisms. Particularly, after first normalization 878 applied to the input tokens and MLP 884 to the conditional tokens, MLP 884 generates or updates post-normalization first scaling and shifting parameters 886, denoted as γ₁, β₁, for post-normalization first scaling and shifting 876 to scale and shift the output of first normalization 878 accordingly. As the normalized input tokens obtained from first normalization 878 are scaled and shifted at post-normalization first scaling and shifting 876 using the conditional information carried as least in γ₁, β₁, this allows the input information and conditional information to interact. Self-attention 874 allows the scaled and shifted normalized input tokens, namely the output from post-normalization first scaling and shifting 876, to attend to each other. MLP 884 also generates or updates first scaling parameter 888 denoted as α₁ for first scaling operations 872 to scale the output of self-attention 874 (e.g., multi-head self-attention), further interacting the input information and conditional information. The input tokens 880 is then summed with the output of first scaling operations 872 at first residual connection 870. In some examples, α₁ has initial values 0, and the DiT Block 896 is initialized as the identity function.

A similar process is performed in a second half of the DiT Block 896. MLP 884 generates or updates post-normalization second scaling and shifting parameters 890, denoted as γ₂, β₂, for post-normalization second scaling and shifting 866 to scale and shift the output of second normalization 868 accordingly. As the output from second normalization 868 is scaled and shifted using the conditional information carried at least in γ₂, β₂, this allows the input information and conditional information to further interact. Feed-forward network 864 then processes the scaled and shifted output from post-normalization second scaling and shifting 866. MLP 884 also generates or updates second scaling parameter 892 denoted as α₂ for second scaling operations 862 to scale the output of feed-forward network 864, further interacting the input information and conditional information. In some cases, the feed-forward network 864 is a pointwise feed-forward network. The output from first residual connection 870 is then summed with the output of second scaling operations 862 at second residual connection 860, and the result is the final output of DiT Block 896. In some examples, α₂ has initial values 0, and the DiT Block 896 is initialized as the identity function. This process repeats for each DiT block in the sequence.

After processing through all DiT block(s) 825, the outputs undergo normalization layer 820 followed by linear and reshape layers 815. The final output is the predicted noise 805, which represents the model's prediction of the noise that was added to initially create the noised latent 840, and the predicted covariance 810, which represents the model's prediction of the covariance. The predicted noise 805 is removed from noised latent 840 at each diffusion timestep, and the predicted covariance may affect how noise is removed or resampled in the reverse or denoising process. At the end of the denoising schedule, the latent sample is decoded to generate the synthetic image in pixel space.

FIG. 9 shows an example of a U-Net 900 according to aspects of the present disclosure. In some examples, U-Net 900 is an example of the component that performs the reverse diffusion process 725 of guided diffusion model 700 described with reference to FIG. 7 and includes architectural elements of the image generation model 1515 described with reference to FIG. 15. The U-Net 900 depicted in FIG. 9 is an example of, or includes aspects of, the architecture used within the reverse diffusion process described with reference to FIG. 7.

In some examples, diffusion models are based on a neural network architecture known as a U-Net. The U-Net 900 takes input features 905 having an initial resolution and an initial number of channels and processes the input features 905 using an initial neural network layer 910 (e.g., a convolutional network layer) to produce intermediate features 915. The intermediate features 915 are then down-sampled using a down-sampling layer 920 such that down-sampled features 925 features have a resolution less than the initial resolution and a number of channels greater than the initial number of channels.

This process is repeated multiple times, and then the process is reversed. That is, the down-sampled features 925 are up-sampled using up-sampling process 930 to obtain up-sampled features 935. The up-sampled features 935 can be combined with intermediate features 915 having the same resolution and number of channels via a skip connection 940. These inputs are processed using a final neural network layer 945 to produce output features 950. In some cases, the output features 950 have the same resolution as the initial resolution and the same number of channels as the initial number of channels.

In some cases, U-Net 900 takes additional input features to produce conditionally generated output. For example, the additional input features could include a vector representation of an input prompt. The additional input features can be combined with the intermediate features 915 within the neural network at one or more layers. For example, a cross-attention module can be used to combine the additional input features and the intermediate features 915.

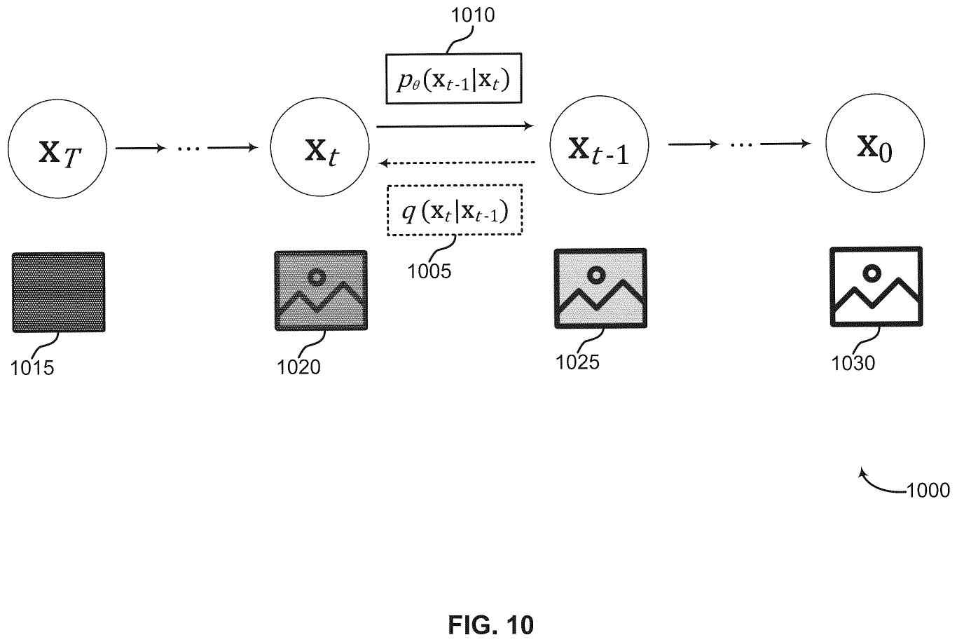

FIG. 10 shows a diffusion process 1000 according to aspects of the present disclosure. In some examples, diffusion process 1000 describes an operation of the image generation model 1515 described with reference to FIG. 15, such as the reverse diffusion process 725 of guided diffusion model 700 described with reference to FIG. 7.

As described above with reference to FIG. 7, using a diffusion model can involve both a forward diffusion process 1005 for adding noise to a media item (or features in a latent space) and a reverse diffusion process 1010 for denoising the media item (or features) to obtain a denoised media item. The forward diffusion process 1005 can be represented as q(xₜ|xₜ₋₁), and the reverse diffusion process 1010 can be represented as p(xₜ₋₁|xₜ). In some cases, the forward diffusion process 1005 is used during training to generate media items with successively greater noise, and a neural network is trained to perform the reverse diffusion process 1010 (i.e., to successively remove the noise).

In an example forward process for a latent diffusion model, the model maps an observed variable x₀ (either in a pixel space or a latent space) intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x_{T} have the same dimensionality as x₀.

The neural network may be trained to perform the reverse process. During the reverse diffusion process 1010, the model begins with noisy data x_{T}, such as a noisy media item 1015 and denoises the data to obtain the p(xₜ₋₁|xₜ). At each step t−1, the reverse diffusion process 1010 takes xₜ, such as first intermediate media item 1020, and t as input. Here, t represents a step in the sequence of transitions associated with different noise levels, The reverse diffusion process 1010 outputs xₜ₋₁, such as second intermediate media item 1025 iteratively until x reverts back to x₀, the original media item 1030. The reverse process can be represented as:

$${p}_{θ} ( {x}_{t - 1} \vert {x}_{t} ) := N ( {x}_{t - 1} ; {μ}_{θ} ( {x}_{t} , t ) , {\sum }_{θ} ( {x}_{t} , t ) ) \qquad ( 3 )$$

The joint probability of a sequence of samples in the Markov chain can be written as a product of conditionals and the marginal probability:

$${x}_{T} : {p}_{θ} ( {x}_{0 : T} ) := p ( {x}_{T} ) {\prod }_{t = 1}^{T} {p}_{θ} ( {x}_{t - 1} \vert {x}_{t} ) \qquad ( 4 )$$

where p(x+)=N(x_{T}; 0, I) is the pure noise distribution as the reverse process takes the outcome of the forward process, a sample of pure noise, as input and

$${\prod }_{t = 1}^{T} {p}_{θ} ( {x}_{t - 1} \vert {x}_{t} )$$

represents a sequence of Gaussian transitions corresponding to a sequence of addition of Gaussian noise to the sample.

At interference time, observed data x₀ in a pixel space can be mapped into a latent space as input and a generated data \tilde{x} is mapped back into the pixel space from the latent space as output. In some examples, x₀ represents an original input media item with low quality, latent variables x₁, . . . , x_{T} represent noisy media items, and \tilde{x} represents the generated item with high quality.

Accordingly, an apparatus for image processing is described. One or more aspects of the apparatus include a memory component; a processing device coupled to the memory component, the processing device configured to perform operations comprising: obtaining an input prompt comprising an object and a depth value for the object; encoding the input prompt to generate a text embedding representing the object and the depth value; and generating, using an image generation model, a synthetic image based on the text embedding, wherein the synthetic image depicts the object having the depth value.

In some aspects, the input prompt further comprises location information indicating a location of the object in the synthetic image. In some aspects, the image generation model comprises a diffusion transformer network. In some aspects, the image generation model is trained using training data including a training prompt comprising a training depth value.

Some examples of the apparatus and system further include a text encoder configured to generate the text embedding. Some examples of the apparatus and system further include generating the synthetic image comprises obtaining a plurality of noisy position encoded image tokens; and denoising the plurality of noisy position encoded image tokens.

### Image Generation Process

According to an embodiment of the present disclosure, the image processing apparatus includes an image generation model that generates a synthetic image. In some cases, the image generation model takes the embedding that incorporates information corresponding to the input prompt, spatial location, and depth information as input and efficiently and accurately generates the synthetic image in a single step. For example, the image generation model comprises a diffusion transformer architecture that generates the synthetic image based on a natural language prompt. In some examples, the image generation model generates a complete image which eliminates use of a pre-defined background.

In some cases, the image generation model is used to integrate an element based on a position of the ellipse. In some cases, the image generation model is used to integrate an element based on a depth information for the ellipse. By incorporating information related to the spatial location and depth of an element during the image decoding process in the diffusion network, embodiments of the present disclosure are able to provide for enhanced flexibility and control for complex, multi-element images. Additionally, by using the ellipse to accurately place the element both spatially and along the z-axis, embodiments enable object-level control to generate a high-quality synthetic image.

The present disclosure describes systems and methods for image generation. Embodiments of the present disclosure include an image processing apparatus that provides for generation of a high-quality synthetic image with precise object control. In some cases, the image processing apparatus takes a prompt and location information (e.g., spatial location and depth disparity value of the element) as input and generates a synthetic image that incorporates each aspect of the input prompt and the location.

The image processing apparatus includes a text encoder and an image generation model. In some cases, the text encoder (e.g., T5 encoder) is configured to encode the input prompt and the location information to generate an embedding. In some cases, the image generation model (e.g., a diffusion transformer network) takes the embedding as input and generates an image token. Subsequently, an image decoder is used to decode the image tokens to generate the synthetic image.

FIG. 11 shows an example of a method 1100 for image processing according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 1105, the system obtains an input prompt including an object and a depth value for the object. In some cases, the operations of this step refer to, or may be performed by, an image processing apparatus as described with reference to FIG. 15.

For example, in some cases, the user interface of the image processing apparatus (such as image processing apparatus 1500 described with reference to FIG. 15) receives an input prompt from a user. In some examples, the input prompt comprises a text query based on which the user wants to generate an image. In some examples, the image processing apparatus receives the input prompt comprising the text query from a database or any other data source.

At operation 1110, the system encodes the input prompt to generate a text embedding representing the object and the depth value. In some cases, the operations of this step refer to, or may be performed by, a text encoder as described with reference to FIGS. 1-5.

An embodiment of the present disclosure includes a text encoder configured to perform an encoding of the input prompt. For example, the input prompt is a text prompt. In some examples, the input prompt includes a text prompt that describes an image or a scene the user wants to generate. Additionally, in some examples, the input prompt includes spatial and depth information associated with an element in the text prompt. In some cases, the text encoder is used to generate a text encoding based on the input (e.g., text) prompt. For example, the text encoding refers to a vector representation corresponding to the input prompt.

At operation 1115, the system generates a synthetic image based on the text embedding, where the synthetic image depicts the object having the depth value. In some cases, the operations of this step refer to, or may be performed by, an image generation model as described with reference to FIG. 15.

An embodiment of the present disclosure includes an image decoder. In some cases, the image decoder is based on a diffusion transformer architecture. In some cases, the diffusion transformer architecture (such as the diffusion transformer architecture described with reference to FIG. 8) is designed to model the distribution P(I|X, Y), where/represents a 128×128 RGB image, X is the image clip embedding, and Y is the text embedding.

The diffusion transformer architecture employs a self-attention mechanism. In some cases, the self-attention mechanism processes a noisy position-encoded image tokens and a conditional feature. For example, the conditional feature includes, but not limited to, a text feature, an image feature, and an identity feature. In some cases, the token is denoised to generate the synthetic image. In some cases, the generated synthetic image is provided to the user via a user interface of the user device (such as user interface and user device described with reference to FIGS. 1 and 14-15).

Accordingly, a method for image processing is described. One or more aspects of the method include obtaining an input prompt comprising an object and a depth value for the object; encoding the input prompt to generate a text embedding representing the object and the depth value; and generating, using an image generation model, a synthetic image based on the text embedding, wherein the synthetic image depicts the object having the depth value.

In some aspects, the input prompt further comprises location information indicating a location of the object in the synthetic image. In some aspects, the location information specifies an ellipse corresponding to the location of the object in the synthetic image.

Some examples of the method, apparatus, and non-transitory computer readable medium further include obtaining the input prompt comprises receiving a visual indication of the location information; and performing a text conversion on the visual indication to obtain the input prompt.

In some aspects, the input prompt comprises a plurality of objects and a plurality of depth values corresponding to the plurality of objects, and wherein the synthetic image depicts the plurality of objects having the plurality of depth values, respectively. In some aspects, the image generation model is trained using training data including a training prompt comprising a training depth value.

Some examples of the method, apparatus, and non-transitory computer readable medium further include generating the synthetic image comprises obtaining a plurality of noisy position encoded image tokens; and denoising the plurality of noisy position encoded image tokens.

Additionally, a method for image processing is described. One or more aspects of the method include obtaining an input prompt comprising an object and three-dimensional (3D) location information for the object; encoding the input prompt to generate a text embedding representing the object and the 3D location information; and generating, using an image generation model, a synthetic image based on the text embedding, wherein the synthetic image depicts the object having the 3D location information.

In some aspects, the 3D location information includes a depth value. In some aspects, the 3D location information specifies an ellipse corresponding to a location of the object in the synthetic image.

Some examples of the method, apparatus, and non-transitory computer readable medium further include receiving a visual indication of the 3D location information. Some examples further include performing a text conversion on the visual indication to obtain the input prompt.

In some aspects, the input prompt comprises a plurality of objects and 3D location information corresponding to the plurality of objects, and wherein the synthetic image depicts the plurality of objects having the 3D location information, respectively. In some aspects, the image generation model is trained using training data including a training prompt comprising a training 3D location information.

Some examples of the method, apparatus, and non-transitory computer readable medium further include obtaining a plurality of noisy position encoded image tokens. Some examples further include denoising the plurality of noisy position encoded image tokens.

### Training the System

According to an exemplary embodiment of the present disclosure, the image generation model is trained to perform image generation conditioned on text or an image. In some examples, the image generation model is trained for 430 k iterations. In some examples, the image generation model is trained and fine-tuned based on appending an identity feature. For example, the image generation model comprises a diffusion transformer network, however, embodiments are not limited thereto, and the image generation model can comprise another diffusion network or a generative model.

FIG. 12 shows an example of a method of training a machine learning model according to aspects of the present disclosure. FIG. 12 is a flow diagram depicting an algorithm as a step-by-step procedure 1200 in an example implementation of operations performable for training a machine-learning model. In some embodiments, the procedure 1200 describes an operation of the training component 1525 described for configuring the image generation model 1515 as described with reference to FIG. 15. The procedure 1200 provides one or more examples of generating training data, use of the training data to train a machine-learning model, and use of the trained machine-learning model to perform a task.

To begin in this example, a machine-learning system collects training data (block 1202) that is to be used as a basis to train a machine-learning model, i.e., which defines what is being modeled. The training data is collectable by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 1204) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

In order to train the machine-learning model in the illustrated example, the machine-learning model is first initialized (block 1206). Initialization of the machine-learning model includes selecting a model architecture (block 1208) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 1210). The loss function is utilized to measure a difference between an output of the machine-learning model (i.e., predictions) and target values (e.g., as expressed by the training data) to be used to train the machine-learning model. Additionally, an optimization algorithm is selected (1212) that is to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 1214) examples of which includes initializing weights and biases of nodes to improve efficiency in training and computational resources consumption as part of training. Hyperparameters are also set that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine-learning model is then trained using the training data (block 1218) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine-learning model to perform an associated task.

As part of training the machine-learning model, a determination is made as to whether a stopping criterion is met (decision block 1220), i.e., which is used to validate the machine-learning model. The stopping criterion is usable to reduce overfitting of the machine-learning model, reduce computational resource consumption, and promote an ability of the machine-learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 1220), the procedure 1200 continues training of the machine-learning model using the training data (block 1218) in this example.

If the stopping criterion is met (“yes” from decision block 1220), the trained machine-learning model is then utilized to generate an output based on subsequent data (block 1222). The trained machine-learning model, for instance, is trained to perform a task as described above and therefore, once trained is configured to perform that task based on subsequent data received as an input and processed by the machine-learning model. The machine learning model is an example of, or includes aspects of, the image generation model described with reference to FIGS. 2, 6-10, and 13-15.

FIG. 13 shows an example of a method of training a diffusion model 1300 according to aspects of the present disclosure. In some embodiments, the method 1300 describes an operation of the training component 1525 described for configuring the image generation model 1515 as described with reference to FIG. 15. The method 1300 represents an example for training a reverse diffusion process as described above with reference to FIGS. 7-10. In some examples, these operations are performed by a system including a processor executing a set of codes to control functional elements of an apparatus, such as the guided diffusion model described in FIG. 7.

Additionally or alternatively, certain processes of method 1300 may be performed using special-purpose hardware. Generally, these operations are performed according to the methods and processes described in accordance with aspects of the present disclosure. In some cases, the operations described herein are composed of various substeps or are performed in conjunction with other operations.

Referring to FIG. 13, according to some aspects, a training component (such as the training component 1525 described with reference to FIG. 15) trains a diffusion model (such as the image generation model described with reference to FIGS. 7-10) to generate an output.

At operation 1305, the user initializes an untrained model. Initialization can include defining the architecture of the model and establishing initial values for the model parameters. In some cases, the initialization can include defining hyper-parameters such as the number of layers, the resolution and channels of each layer blocks, the location of skip connections, and the like.

At operation 1310, the system adds noise to a training image (or an additional training image) using a forward diffusion process (such as the forward diffusion process described with reference to FIG. 7) in N stages. In some cases, the operations of this step refer to, or may be performed by, a training component as described with reference to FIG. 15.

At operation 1315, the system at each stage n, starting with stage N, a reverse diffusion process is used to predict the output or features at stage n−1. For example, the reverse diffusion process can predict the noise that was added by the forward diffusion process, and the predicted noise can be removed from the noise input to obtain the predicted output. In some cases, an original media item is predicted at each stage of the training process.

At operation 1320, the system compares predicted output (or features) at stage n−1 to an actual media item (or features), such as the output at stage n−1 or the original input. For example, given observed data x, the diffusion model may be trained to minimize the variational upper bound of the negative log-likelihood-log pe (x) of the training data.

At operation 1325, the system updates parameters of the model based on the comparison. For example, parameters of a U-Net may be updated using gradient descent. Time-dependent parameters of the Gaussian transitions can also be learned.

### Computing Device

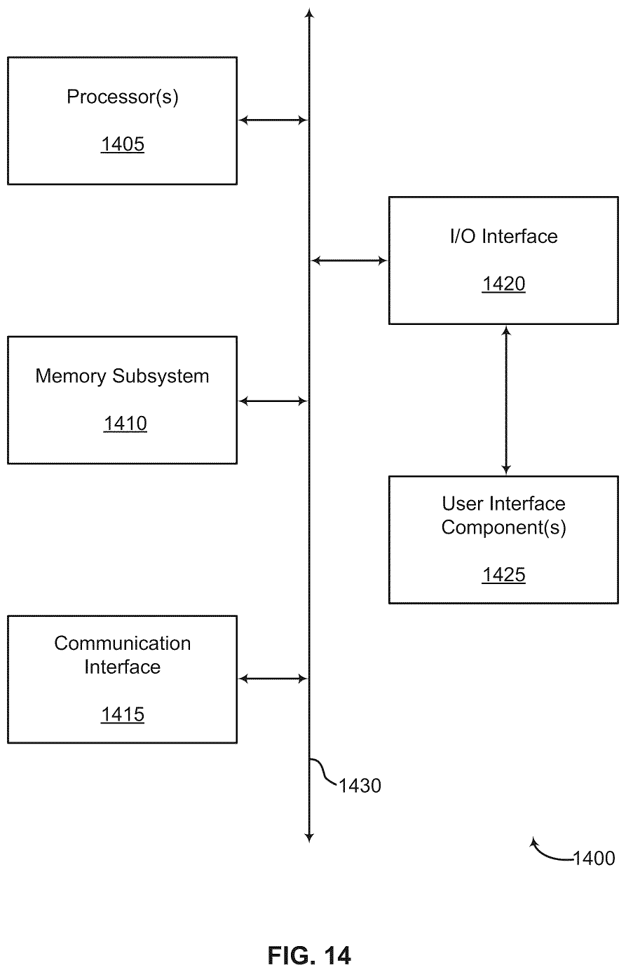

FIG. 14 shows an example of a computing device according to aspects of the present disclosure. The computing device 1400 may be an example of the image processing apparatus 1500 described with reference to FIG. 15. In one aspect, computing device 1400 includes processor(s) 1405, memory subsystem 1410, communication interface 1415, I/O interface 1420, user interface component(s) 1425, and channel 1430.

In some embodiments, computing device 1400 is an example of, or includes aspects of, the image generation model of FIG. 15. In some embodiments, computing device 1400 includes one or more processors 1405 that can execute instructions stored in memory subsystem 1410 to perform media generation.

According to some aspects, computing device 1400 includes one or more processors 1405. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 1410 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1415 operates at a boundary between communicating entities (such as computing device 1400, one or more user devices, a cloud, and one or more databases) and channel 1430 and can record and process communications. In some cases, communication interface 1415 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1420 is controlled by an I/O controller to manage input and output signals for computing device 1400. In some cases, I/O interface 1420 manages peripherals not integrated into computing device 1400. In some cases, I/O interface 1420 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1420 or via hardware components controlled by the I/O controller.

According to some aspects, user interface component(s) 1425 enable a user to interact with computing device 1400. In some cases, user interface component(s) 1425 include an audio device, such as an external speaker system, an external display device such as a display screen, an input device (e.g., a remote-control device interfaced with a user interface directly or through the I/O controller), or a combination thereof. In some cases, user interface component(s) 1425 include a GUI.

FIG. 15 shows an example of an image processing apparatus 1500 according to aspects of the present disclosure. Image processing apparatus 1500 is an example of, or includes aspects of, the corresponding element described with reference to FIGS. 1-5. In one aspect, image processing apparatus 1500 includes processor unit 1505, memory unit 1510, I/O module 1520, and training component 1525. Training component 1525 updates parameters of the image generation model 1515 stored in memory unit 1510. In some examples, the training component 1525 is located outside the image processing apparatus 1500.

According to some aspects, image processing apparatus 1500 obtains an input prompt including an object and a depth value for the object. In some aspects, the input prompt further includes location information indicating a location of the object in the synthetic image. In some aspects, the location information specifies an ellipse corresponding to the location of the object in the synthetic image. In some examples, image processing apparatus 1500 obtains the input prompt including receiving a visual indication of the location information; and performing a text conversion on the visual indication to obtain the input prompt. In some aspects, the input prompt includes a set of objects and a set of depth values corresponding to the set of objects, and where the synthetic image depicts the set of objects having the set of depth values, respectively.

According to some aspects, image processing apparatus 1500 obtains an input prompt including an object and three-dimensional (3D) location information for the object. In some aspects, the 3D location information includes a depth value. In some aspects, the 3D location information specifies an ellipse corresponding to a location of the object in the synthetic image. In some examples, image processing apparatus 1500 receives a visual indication of the 3D location information. In some examples, image processing apparatus 1500 performs a text conversion on the visual indication to obtain the input prompt. In some aspects, the input prompt includes a set of objects and 3D location information corresponding to the set of objects, and where the synthetic image depicts the set of objects having the 3D location information, respectively.

According to some aspects, image processing apparatus 1500 comprises obtaining an input prompt including an object and a depth value for the object. In some aspects, the input prompt further includes location information indicating a location of the object in the synthetic image.

According to some aspects, processor unit 1505 comprises a processing device coupled to the memory component. Processor unit 1505 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

In some cases, processor unit 1505 is configured to operate a memory array using a memory controller. In other cases, a memory controller is integrated into processor unit 1505. In some cases, processor unit 1505 is configured to execute computer-readable instructions stored in memory unit 1510 to perform various functions. In some aspects, processor unit 1505 includes special purpose components for modem processing, baseband processing, digital signal processing, or transmission processing. According to some aspects, processor unit 1505 comprises one or more processors described with reference to FIG. 14.

Memory unit 1510 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 1505 to perform various functions described herein.

In some cases, memory unit 1510 includes a basic input/output system (BIOS) that controls basic hardware or software operations, such as an interaction with peripheral components or devices. In some cases, memory unit 1510 includes a memory controller that operates memory cells of memory unit 1510. For example, the memory controller may include a row decoder, column decoder, or both. In some cases, memory cells within memory unit 1510 store information in the form of a logical state. According to some aspects, memory unit 1510 is an example of the memory subsystem 1410 described with reference to FIG. 14.

According to some aspects, image processing apparatus 1500 uses one or more processors of processor unit 1505 to execute instructions stored in memory unit 1510 to perform functions described herein. For example, the image processing apparatus 1500 may obtain an input prompt comprising an object and a depth value for the object; encode the input prompt to generate a text embedding representing the object and the depth value; and generate, using an image generation model, a synthetic image based on the text embedding, wherein the synthetic image depicts the object having the depth value.

In one aspect, memory unit 1510 includes image generation model 1515 trained to obtain an input prompt comprising an object and a depth value for the object; encode the input prompt to generate a text embedding representing the object and the depth value; and generate, using an image generation model, a synthetic image based on the text embedding, wherein the synthetic image depicts the object having the depth value.

For example, after training, the image generation model 1515 may perform inferencing operations as described with reference to FIGS. 1-5 to obtain an input prompt comprising an object and a depth value for the object; encode the input prompt to generate a text embedding representing the object and the depth value; and generate, using an image generation model, a synthetic image based on the text embedding, wherein the synthetic image depicts the object having the depth value.

In some embodiments, the image generation model 1515 is an Artificial neural network (ANN) comprising a plurality of networks including the guided diffusion model described with reference to FIG. 7, the diffusion transformer architecture described with reference to FIG. 8, and the U-Net described with reference to FIG. 9. An ANN can be a hardware component or a software component that includes connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

ANNs have numerous parameters, including weights and biases associated with each neuron in the network, which control the degree of connection between neurons and influence the neural network's ability to capture complex patterns in data. These parameters, also known as model parameters or model weights, are variables that determine the behavior and characteristics of a machine learning model.

In some cases, the signals between nodes comprise real numbers, and the output of each node is computed by a function of its inputs. For example, nodes may determine their output using other mathematical algorithms, such as selecting the max from the inputs as the output, or any other suitable algorithm for activating the node. Each node and edge are associated with one or more node weights that determine how the signal is processed and transmitted. In some cases, nodes have a threshold below which a signal is not transmitted at all. In some examples, the nodes are aggregated into layers.

The parameters of image generation model 1515 can be organized into layers. Different layers perform different transformations on their inputs. The initial layer is known as the input layer and the last layer is known as the output layer. In some cases, signals traverse certain layers multiple times. A hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

Training component 1525 may train the image generation model 1515. For example, parameters of the image generation model 1515 can be learned or estimated from training data and then used to make predictions or perform tasks based on learned patterns and relationships in the data. In some examples, the parameters are adjusted during the training process to minimize a loss function or maximize a performance metric (e.g., as described with reference to FIG. 11). The goal of the training process may be to find optimal values for the parameters that allow the image generation model to make accurate predictions or perform well on the given task.

Accordingly, the node weights can be adjusted to improve the accuracy of the output (i.e., by minimizing a loss which corresponds in some way to the difference between the current result and the target result). The weight of an edge increases or decreases the strength of the signal transmitted between nodes. For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the image generation model 1515 can be used to make predictions on new, unseen data (i.e., during inference).

According to some aspects, image generation model 1515 generates a synthetic image based on the text embedding, where the synthetic image depicts the object having the depth value. In some examples, image generation model 1515 generates the synthetic image including obtaining a set of noisy position encoded image tokens; and denoising the set of noisy position encoded image tokens. In some aspects, the image generation model 1515 is trained using training data including a training prompt including a training depth value.

According to some aspects, image generation model 1515 generates a synthetic image based on the text embedding, where the synthetic image depicts the object having the 3D location information. In some examples, image generation model 1515 obtains a set of noisy position encoded image tokens. In some examples, image generation model 1515 denoises the set of noisy position encoded image tokens. In some aspects, the image generation model 1515 is trained using training data including a training prompt including a training 3D location information.

According to some aspects, image generation model 1515 generates a synthetic image based on the text embedding, wherein the synthetic image depicts the object having the depth value. In some aspects, the image generation model 1515 includes a diffusion transformer network. In some aspects, the image generation model 1515 is trained using training data including a training prompt including a training depth value. In some examples, image generation model 1515 comprise generates the synthetic image including: obtaining a set of noisy position encoded image tokens; and denoising the set of noisy position encoded image tokens.

I/O module 1520 receives inputs from and transmits outputs of the image processing apparatus 1500 to other devices or users. For example, I/O module 1520 receives inputs for the image generation model 1515 and transmits outputs of the image generation model 1515. According to some aspects, I/O module 1520 is an example of the I/O interface 1420 described with reference to FIG. 14.

As used herein, an “embedding” (such as a feature representation, a contextualized visual representation, a summary visual representation, a preliminary visual representation, a text feature, or a text-conditioned visual feature) refers to a representation of an object (e.g., a frame of a video, or a sentence of a transcript) in a lower-dimensional space such that semantic information about the object is more easily captured and analyzed by a machine learning model. An example embedding is a numerical representation of the object in a continuous vector space in which objects that include similar semantic information to each other correspond to vectors that are numerically similar to and thus “closer” to each other, thereby allowing a similarity between different objects corresponding to different embeddings to be readily determined.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method for image processing, comprising:
obtaining an input prompt comprising a representation of an object and a depth value for the object;
encoding the input prompt to generate a text embedding representing the object and the depth value; and
generating, using an image generation model, a synthetic image based on the text embedding, wherein the synthetic image depicts the object having the depth value.

2. The method of claim 1, wherein:
the input prompt further comprises location information indicating a location of the object in the synthetic image.

3. The method of claim 2, wherein:
the location information specifies an ellipse corresponding to the location of the object in the synthetic image.

4. The method of claim 2, wherein obtaining the input prompt comprises:
receiving a visual indication of the location information; and
performing a text conversion on the visual indication to obtain the input prompt.

5. The method of claim 1, wherein:
the input prompt comprises a plurality of objects and a plurality of depth values corresponding to the plurality of objects, and wherein the synthetic image depicts the plurality of objects having the plurality of depth values, respectively.

6. The method of claim 1, wherein generating the synthetic image comprises:
obtaining a plurality of noisy position encoded image tokens; and
denoising the plurality of noisy position encoded image tokens.

7. The method of claim 1, wherein:
the image generation model is trained using training data including a training prompt comprising a training depth value.

8. A non-transitory computer readable medium storing code for image processing, the code comprising instructions that, when executed by at least one processor, causes the at least one processor to perform operations comprising:
obtaining an input prompt comprising a representation of an object and three-dimensional (3D) location information for the object;
encoding the input prompt to generate a text embedding representing the object and the 3D location information; and
generating, using an image generation model, a synthetic image based on the text embedding, wherein the synthetic image depicts the object having the 3D location information.

9. The non-transitory computer readable medium of claim 8, wherein:
the 3D location information includes a depth value.

10. The non-transitory computer readable medium of claim 8, wherein:
the 3D location information specifies an ellipse corresponding to a location of the object in the synthetic image.

11. The non-transitory computer readable medium of claim 8, wherein obtaining the input prompt comprises:
receiving a visual indication of the 3D location information; and
performing a text conversion on the visual indication to obtain the input prompt.

12. The non-transitory computer readable medium of claim 8, wherein:
the input prompt comprises a plurality of objects and 3D location information corresponding to the plurality of objects, and wherein the synthetic image depicts the plurality of objects having the 3D location information, respectively.

13. The non-transitory computer readable medium of claim 8, wherein generating the synthetic image comprises:
obtaining a plurality of noisy position encoded image tokens; and
denoising the plurality of noisy position encoded image tokens.

14. The non-transitory computer readable medium of claim 8, the code further comprising instructions that, when executed by the at least one processor, causes the at least one processor to perform operations comprising:
the image generation model is trained using training data including a training prompt comprising a training 3D location information.

15. A system comprising:
a memory component; and
a processing device coupled to the memory component, the processing device configured to perform operations comprising:
obtaining an input prompt comprising a representation of an object and a depth value for the object;
encoding the input prompt to generate a text embedding representing the object and the depth value; and
generating, using an image generation model, a synthetic image based on the text embedding, wherein the synthetic image depicts the object having the depth value.

16. The system of claim 15, further comprising:
a text encoder configured to generate the text embedding.

17. The system of claim 15, wherein:
the input prompt further comprises location information indicating a location of the object in the synthetic image.

18. The system of claim 15, wherein:
the image generation model comprises a diffusion transformer network.

19. The system of claim 15, wherein:
the image generation model is trained using training data including a training prompt comprising a training depth value.

20. The system of claim 15, wherein generating the synthetic image comprises:
obtaining a plurality of noisy position encoded image tokens; and
denoising the plurality of noisy position encoded image tokens.
